(19) United States
(12) Patent Application Publication
(10) Pub. No.: US 2005/0255299 A1
(43) Pub. Date: Nov. 17, 2005

(54) Invisible temporary tattoo

(76) Inventor: Sun Yu, Berkley, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/847,015

(22) Filed: May 17, 2004

(51) Int. Cl. B32B 3/00

(52) U.S. Cl. 428/195.1

(57) ABSTRACT

An improved temporary tattoo becomes discernable only under an illumination wavelength of a violet or a shorter wavelength.

### FIELD OF THE INVENTION

The present invention in general relates to a temporary tattoo, and in particular to a tattoo that becomes readily discernable only under ultraviolet, black light or still shorter wavelength incident light.

### BACKGROUND OF THE INVENTION

Decals and temporary tattoos are well known to the art. Decals have a long history in the ceramics industry for the transfer of repetitive complex patterns onto china. Decals were later adopted by model makers to decorate miniatures with emblems and insignia indicative of the original object. With more pliable and skin compatible backings, the application of decals to human skin to form temporary tattoos became prevalent, while various materials and laminated structures have been used to enhance wearability and make temporary tattoos amenable to well known printing techniques, such as silk screening, offset printing and lithographic printing. Regardless of the temporary tattoo materials, structure, and printing technique, all prior art temporary tattoos share the common attribute of having a design discernable under visible light.

Visible light temporary tattoos have also been created that incorporate designs discernable under ultraviolet or violet incident light. As the intended purpose of a temporary tattoo is decorative and also to garner attention within a subculture, it is of a benefit to a temporary tattoo wearer to display a tattoo that suddenly becomes discernable in a nightclub or other social setting having black light fixtures. Thus, there exists a need for a temporary, invisible ink tattoo.

### SUMMARY OF THE INVENTION

An improved temporary tattoo becomes discernable only under an illumination wavelength of a violet or a shorter wavelength. The inventive temporary tattoo optionally also includes a protective layer intermediate between the ink layer and slip coating layer. Likewise, an additional intermediate barrier layer is optionally disposed between the contact adhesive and ink layer. The ink layer is applied by conventional printing techniques including lithographic printing and silk screening. Multiple invisible inks are operative herein to yield an image in the visible wavelength spectrum that appears to have multiple colors under illumination wavelength but is otherwise not discernable under incident visible light. The inventive tattoo optionally has a series of perforations therethrough to facilitate skin perspiration.

### BRIEF DESCRIPTION OF THE DRAWING

The present invention is further detailed with respect to the following which depicts exemplary, non-limiting embodiments thereof.

FIG. 1 is an exploded view of an inventive invisible ink temporary tattoo.

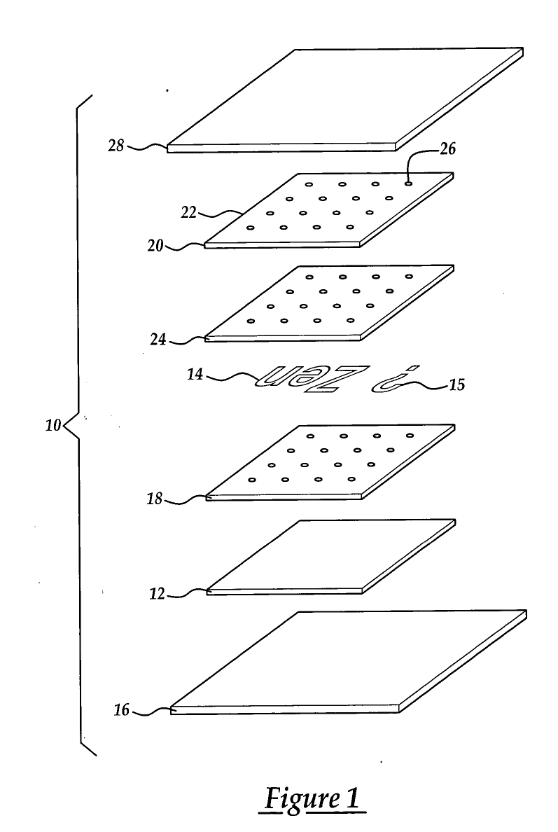

### DETAILED DESCRIPTION OF THE PREFERRED EMBODIMENTS

The present invention has utility as a temporary tattoo, the image of which only becomes visible to the human eye under violet or ultraviolet wavelength incident light. It is appreciated that an inventive invisible tattoo can reside in overlap or adjacent to a conventional visible tattoo. A tattoo according to the present invention garners considerable attention in social settings having black light illumination. The invisible ink tattoo according to the present invention provides a skin compatible invisible ink and/or a dye impervious barrier layer intermediate between wearer skin and a dye layer of an inventive tattoo.

Referring now to the FIGURE, an inventive tattoo is shown generally at 10. Inventive temporary tattoo 10 is suitable for application to skin or another flat surface to provide a simulation of an actual tattoo with the proviso that the ink is only visible under violet or ultraviolet incident light. The tattoo 10 has a slip coating layer 12 which is intermediate between an invisible ink printing 14 and conventional decal paper 16. A visible ink printing 15 optionally also is provided. The slip coating layer 12 has the characteristic of being soluble in the solvent applied to the decal paper in order to release the decal paper 16 therefrom. While water is the most common solvent used in the application of an inventive tattoo 10, it is appreciated that other skin compatible solvents illustratively include isopropanol and acetone. The slip coating layer 12 is formed of any skin compatible substance amenable to formation as a film and soluble in the application solvent. While the invisible ink printing 14 can be applied directly onto a slip coating layer 12 provided the ink and solvents therefor do not dissolve the slip coating layer 12, it is preferred that the invisible ink printing 14 and the optional visible ink 15 be applied to a protective layer 18. The protective layer 18 serves to protect the invisible ink printing 14 and the optional visible ink 15 during the time that temporary tattoo 10 is applied to a substrate. The protective layer 18 is a water-resistant film that also serves to protect the underlying invisible ink printing 14 against disruption caused by mild abrasion. The protective layer 18 is readily formed from a variety of hydrophobic materials illustratively including conventional offset printing varnish, natural or synthetic hydrophilic substances formable as a thin film. Typically, the protective layer 18, when present, has a thickness of between 0.1 and 500 microns. The protective film 18 optionally includes particulate or additives to reduce the sheen thereof and thereby form a matte appearance to the tattoo 10. The conventional components of an inventive tattoo are well known to the art as illustrated in U.S. Pat. Nos. 2,941,916; 4,175,151; 4,522,864; and 6,074,721, which are each incorporated herein by reference.

As used herein, invisible ink is used synonymously with ultraviolet (UV) ink and is defined to include an ink having a dye molecule that fluoresces or phosphoresces in the portion of the light spectrum discernable to the human eye upon exposure to incident ultraviolet or violet light. Suitable UV inks operative in the present invention are available from UV Light Technology, Limited, Birmingham, England. Conventional UV inks operative herein illustratively include monoazo xanthenes, monoazo anthraquinones, monoazo stilbenes, and alkyl benzoxazolyl thiophenes. It is appreciated that more than one invisible ink can be applied to form an invisible ink printing 14 so as to form an image under illumination that is polychromatic in appearance. A particularly preferred invisible ink composition includes from about 0.5 to 40 weight percent of the active invisible ink dye in a base including acrylate copolymer, sucrose acetate isobutyrate, dipropylene glycol dibenzoate, polyvinyl butyrate, cellulose and bis(t-butyl benzoxazolyl) thiophene. This particular invisible ink composition is well suited to form invisible ink layer 14 that is well suited to form a stable ink layer resistant to abrasion damage independent of a protective layer 18.

An adhesive layer 20 is applied to the rearward surface 22 of the invisible ink layer 14. The adhesive layer 20 includes an adhesive compatible with prolonged contact to human skin or other substrates. The adhesive within the adhesive layer 20 is of a skin compatible adhesive conventional to the art and illustratively includes acrylics, mucilage, and collagens. Optionally, intermediate between the adhesive layer 20 and the rearward surface 22 of the invisible ink layer 14 is a barrier layer 24 to prevent diffusion therebetween. A barrier layer 24 optionally includes additives to reduce gloss, provide colorization or metallization, or otherwise enhance the visual effects of the tattoo 10. The barrier layer 24 is illustratively formed of conventional hydrophobic polymeric materials illustratively including nylon, polyalkenes, polystyrenes, and polyesters.

As much of the degradation associated with a conventional temporary tattoo is associated with perspiration being trapped between the skin and the overlying tattoo, in an alternate embodiment an inventive tattoo includes multiple through-perforations 26 to allow perspiration to perfuse through the tattoo 10 and thereby enhance the durability of the skin-adhesive layer 20 interfacial contact.

An inventive invisible ink printing is applied by conventional printing techniques illustratively including silk screening, and offset printing.

A peelable protective sheet 28 overlies the adhesive layer 24 in order to preserve the tack thereof prior to application. The protective sheet 28 preferably has a low surface tension surface in contact with the adhesive layer 24 in order to facilitate peelable release. A low surface tension surface of a protective sheet 28 is illustratively formed of silicone or fluoropolymer materials.

The process by which an inventive tattoo 10 is applied includes removal of the protective sheet 28 to expose the adhesive layer 24. The inventive tattoo is then placed in contact with the skin or other suitable substrate such that the adhesive layer 24 is in contact therewith. The decal paper 16 is then moistened with a skin compatible solvent. The solvent is wicked through the decal paper 16 to dissolve the slip coating layer 12, thereby allowing the decal paper 16 to be peeled away from the inventive tattoo 10 which is now adhered to the substrate.

All patents and publications cited herein are indicative of the level of skill in the art to which the invention pertains. Each patent and publication cited herein is incorporated by reference to the same extent as if each individual patent and publication was individually and explicitly incorporated by reference.

It is to be understood that various modifications are readily made to the embodiments of the present invention described herein without departing from the spirit and scope thereof. Accordingly, it is to be understood that the invention is not to be limited by the specific illustrated embodiment, but by the scope of the appended claims.

1. An improved temporary tattoo having a contact adhesive compatible with skin, an ink layer, a slip layer to release the ink layer from an overlying decal paper upon solvent saturation wherein the improvement lies in: the ink layer being discernable to an unaided human eye only under an illumination wavelength of violet or a shorter wavelength.

2. The improved temporary tattoo of claim 1 wherein the illumination wavelength is ultraviolet.

3. The improved temporary tattoo of claim 1 wherein the illumination wavelength is ultraviolet-A.

4. The improved temporary tattoo of claim 1 wherein the illumination wavelength is an emission from a black light source.

5. The improved temporary tattoo of claim 1 wherein the ink layer is printed lithographically.

6. The improved temporary tattoo of claim 1 wherein the ink layer is silk screened.

7. The improved temporary tattoo of claim 1 having the further improvement of a plurality of inks within the ink layer to yield an image under an illumination wavelength, the image having multiple visible spectrum colors.

8. The improved temporary tattoo of claim 1 having the further improvement of a plurality of perforations extending through the contact adhesive and the ink layer.

9. The improved temporary tattoo of claim 1 having the further improvement of a light diffusion additive to give the temporary tattoo a matte finish.

10. The improved temporary tattoo of claim 1 having the further improvement of: a visible ink image printed in overlap or adjacent to the ink layer.
